(19) United States
(12) Patent Application Publication
(10) Pub. No.: US 2013/0194489 A1
(43) Pub. Date: Aug. 1, 2013

(54) IMAGING DEVICE

(71) Applicant: Panasonic Corporation, Osaka (JP)

(72) Inventor: Shusaku YAMAMOTO, Osaka (JP)

(73) Assignee: Panasonic Corporation, Osaka (JP)

(21) Appl. No.: 13/747,401

(22) Filed: Jan. 22, 2013

(30) Foreign Application Priority Data
Jan. 30, 2012 (JP) 2012-017217

(51) Int. Cl. H04N 5/225

(52) U.S. Cl. CPC H04N 5/2251
USPC 348/373

(57) ABSTRACT

An imaging device includes a flat printed substrate, a first lens barrel, a second lens barrel, a first rigid flexible substrate and a second rigid flexible substrate. The first rigid flexible substrate has a first flexible component, a first rigid component and a first electronic circuit component. The first flexible component is connected to the first imaging element and the first connector. The first rigid component is disposed in the rear of the first lens barrel. The first electronic circuit component is supported by the first rigid component. At least part of the first flexible component and/or the first electronic circuit component is disposed in front of the rear face of the flat printed substrate. At least part of the second flexible component and/or the second electronic circuit component is disposed in front of the rear face of the flat printed substrate.

### CROSS-REFERENCE TO RELATED APPLICATIONS

This application claims priority under 35 U.S.C. §119 to Japanese Patent Application No. 2012-017217, filed on Jan. 30, 2012. The entire disclosure of Japanese Patent Application No. 2012-017217 is hereby incorporated herein by reference.

### BACKGROUND

1. Technical Field

The present invention relates to an imaging device comprising imaging elements and a printed substrate.

2. Background Information

Patent Literature Japanese Laid-Open Patent Application 2009-147477 discloses an imaging device comprising an imaging element disposed at the lower end of a lens barrel, a printed substrate disposed along the side face of the lens barrel, and a flexible substrate linked to the imaging element and the printed substrate.

### SUMMARY

However, with the imaging device in Patent Literature Japanese Laid-Open Patent Application 2009-147477, since a connector of the flexible substrate is disposed on the printed substrate that is disposed along the side face of the lens barrel, the imaging device ends up being larger in the width direction. Also, if the printed substrate is disposed along the rear face of the lens barrel, the imaging device will end up being larger in the longitudinal direction.

The technology disclosed herein was conceived in light of the above situation, and it is an object thereof to provide an imaging device that can be made more compact.

An imaging device disclosed herein includes a flat printed substrate, a first lens barrel, a second lens barrel, a first rigid flexible substrate and a second rigid flexible substrate. The flat printed substrate has a front face, a rear face, a first connector, and a second connector. The first connector and the second connector are disposed on the rear face. The first lens barrel is disposed on a front face side of the printed substrate. The first lens barrel has a first imaging element. The second lens barrel is disposed on the front face side of the printed substrate. The second lens barrel has a second imaging element. The first rigid flexible substrate is linked to the first imaging element and the first connector. The second rigid flexible substrate is linked to the second imaging element and the second connector. The first rigid flexible substrate has a first flexible component, a first rigid component and a first electronic circuit component. The first flexible component is connected to the first imaging element and the first connector. The first rigid component is disposed in the rear of the first lens barrel. The first electronic circuit component is supported by the first rigid component. The second rigid flexible substrate has a second flexible component, a second rigid component and second electronic circuit component. The second flexible component is connected to the second imaging element and the second connector. The second rigid component is disposed in the rear of the second lens barrel. The second electronic circuit component is supported by the second rigid component. At least part of the first flexible component and/or the first electronic circuit component is disposed in front of the rear face of the printed substrate. At least part of the second flexible component and/or the second electronic circuit component is disposed in front of the rear face of the printed substrate.

The imaging device disclosed herein can be made more compact.

### BRIEF DESCRIPTION OF DRAWINGS

Referring now to the attached drawings which form a part of this original disclosure:

FIG. 1 is a front oblique view of a digital camera;

FIG. 2 is a rear oblique view of the digital camera;

FIG. 3 is a front exploded oblique view of the digital camera;

FIG. 4 is a front exploded oblique view of a frame assembly;

FIG. 5 is a rear exploded oblique view of the frame assembly;

FIG. 6 is a front oblique view of a first rigid flexible substrate;

FIG. 7 is a rear oblique view of the first rigid flexible substrate;

FIG. 8 is a rear view of first and second rigid flexible substrates;

FIG. 9 is an example of an A-A cross section of FIG. 8; and

FIG. 10 is an example of an A-A cross section of FIG. 8.

### DETAILED DESCRIPTION

Selected embodiments of the present invention will be described through reference to the drawings. In the following description of the drawings, those portions that are the same or similar will be given the same or similar numbers. The drawings are merely illustrative in nature and the proportions of the various dimensions and so forth may differ from those in actuality. Therefore, the specific dimensions and so forth should be determined by reference to the following description. Also, it should go without saying that dimensional relations and proportions may vary from one drawing to the next. It will be apparent to those skilled in the art from this disclosure that the following descriptions of the embodiments are provided for illustration only and not for the purpose of limiting the invention as defined by the appended claims and their equivalents

The following embodiment will be described using a digital camera as an example of an imaging device. In the following description, assuming that the digital camera is in its normal orientation (hereinafter also referred to as landscape orientation), the direction facing the subject will be referred to as “forward,” the direction facing away from the subject as “rearward,” vertically upward as “upward,” vertically downward as “downward,” to the right in a state of facing directly at the subject as “to the right,” and to the left in a state of facing directly at the subject as “to the left.”

Overall Configuration of Digital Camera 1

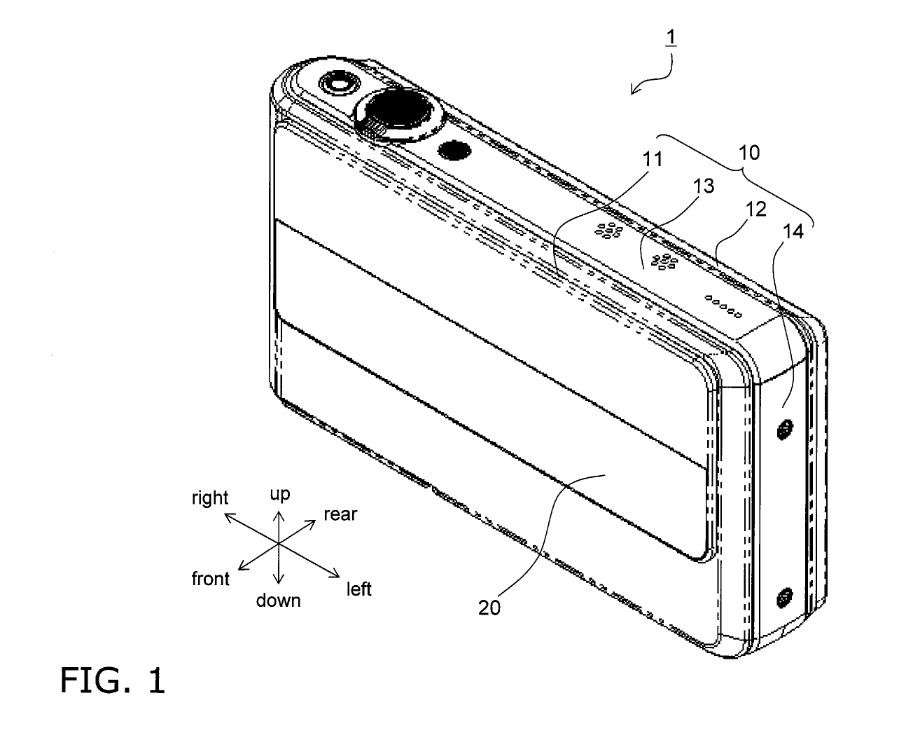

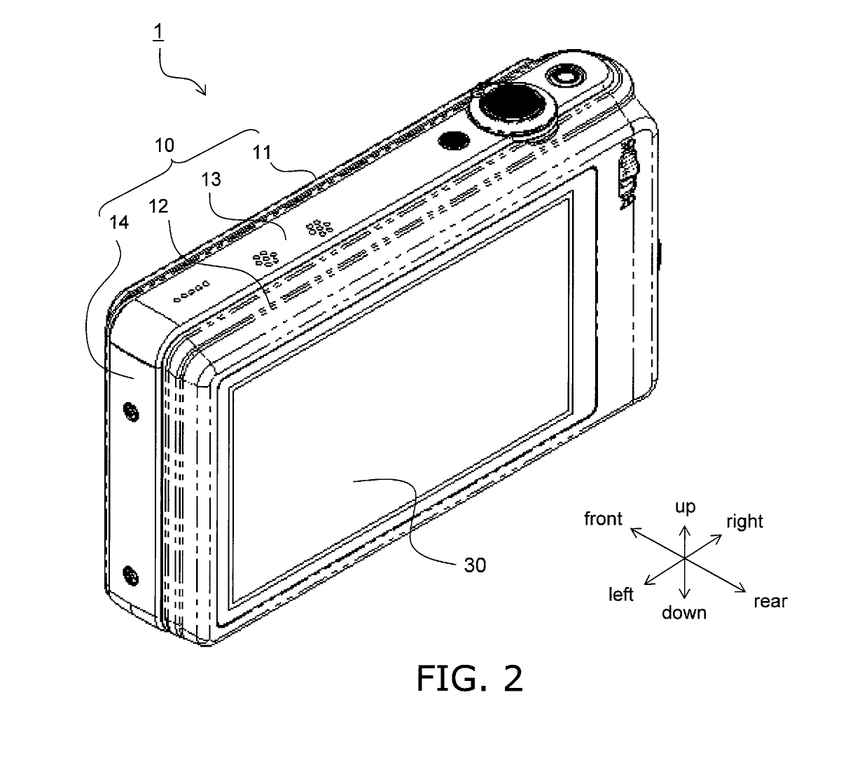

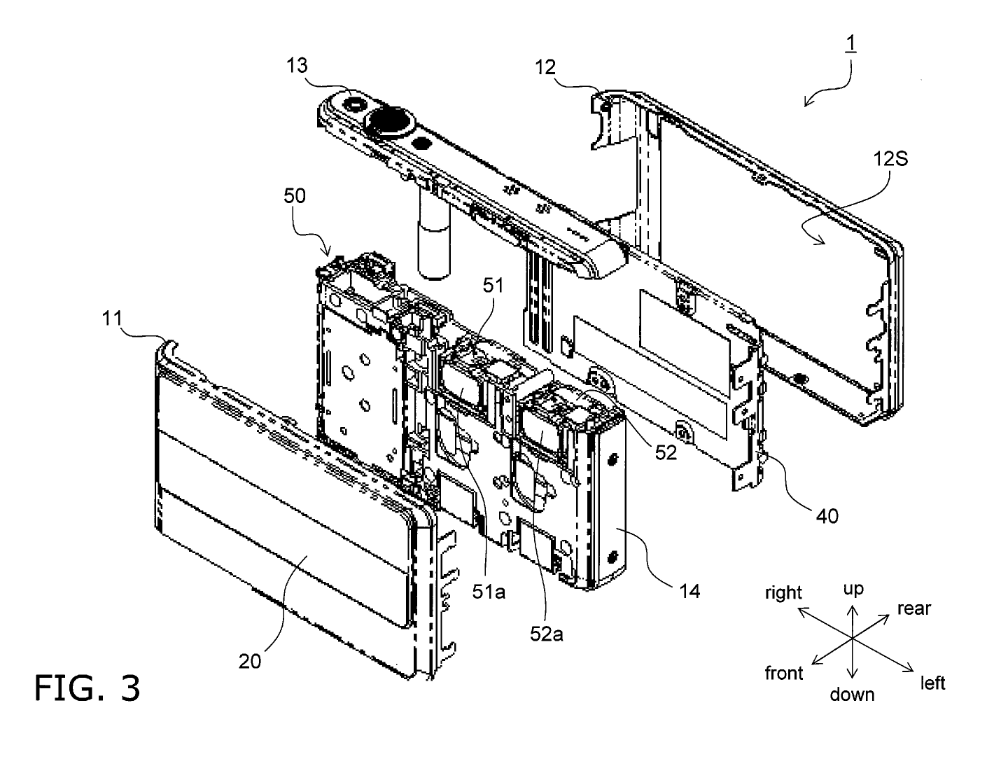

The overall configuration of a digital camera 1 pertaining to an embodiment will be described through reference to the drawings. FIG. 1 is a front oblique view of the digital camera 1. FIG. 2 is a rear oblique view of the digital camera 1. FIG. 3 is a front exploded oblique view of the digital camera 1. A monitor 30 is not shown in FIG. 3.

The digital camera 1 comprises a housing 10, a slide cover 20, the monitor 30, a frame plate 40, and a frame assembly 50.

The housing 10 is made up of a front panel 11, a rear panel 12, a top panel 13, and a side panel 14. The front panel 11 is disposed in front of the frame assembly 50. The rear panel 12 is disposed in the rear of the frame panel 40. A monitor opening 12S into which the monitor 30 is fitted is formed in the rear panel 12. The top panel 13 is disposed above the frame assembly 50. The side panel 14 is disposed to the right of the frame assembly 50.

The slide cover 20 is attached to the front panel 11 so as to slide up and down. When the slide cover 20 is slid upward, first and second lens barrels 51 and 52 (discussed below) are closed, and when the slide cover 20 is slid downward, the first and second lens barrels 51 and 52 are opened.

The monitor 30 is fitted into the monitor opening 12S in the rear panel 12. The frame plate 40 supports the inner face of the monitor 30 and covers the rear of the frame assembly 50.

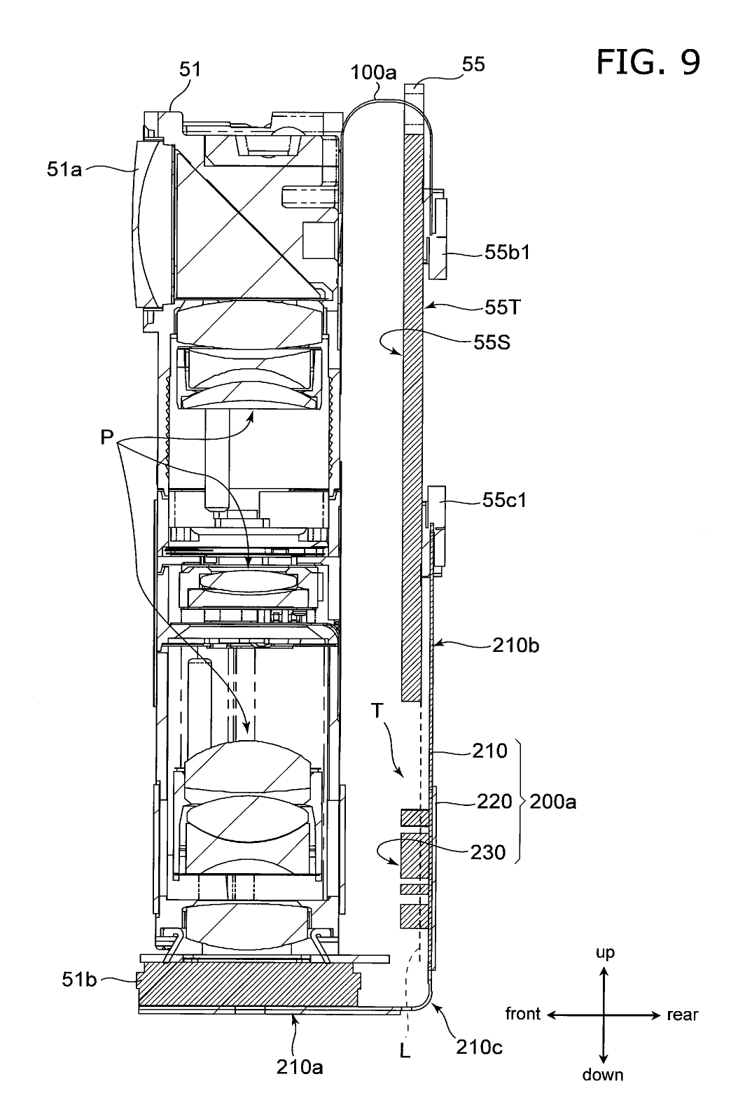

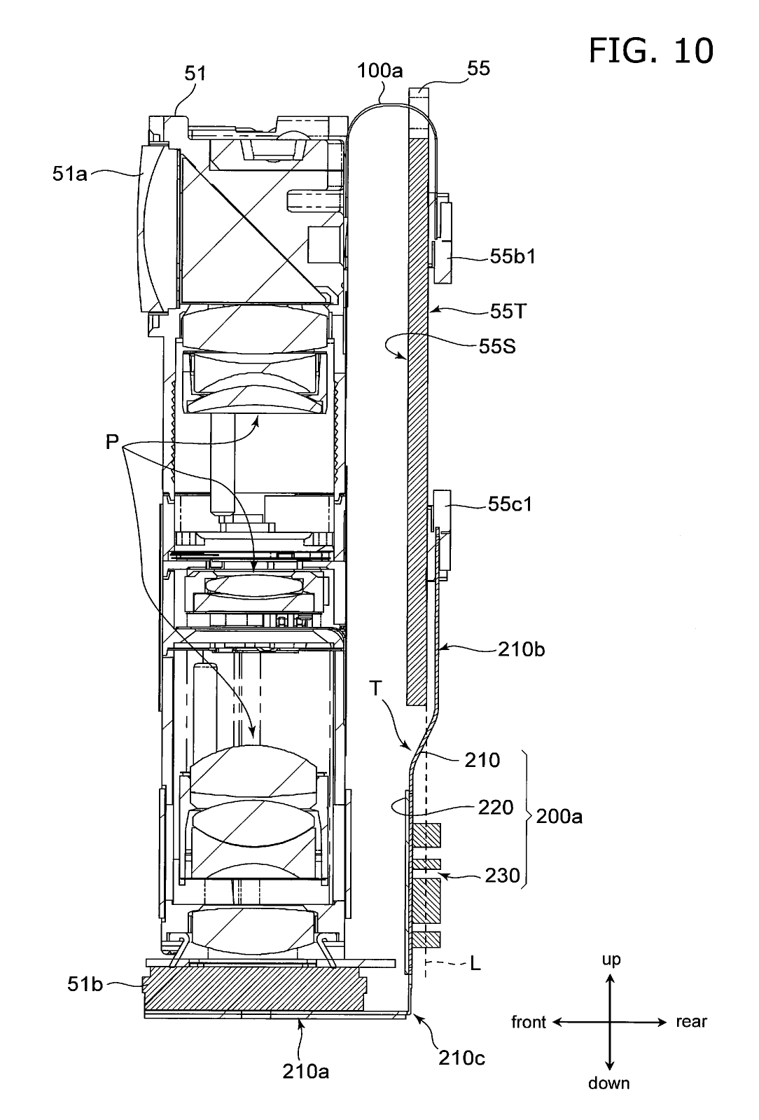

The frame assembly 50 is disposed between the front panel 11 and the frame plate 40. The frame assembly 50 has the first and second lens barrels 51 and 52. Built into the first lens barrel 51 is a bending optical system P including a first front lens 51a (not shown in FIGS. 1 to 3; see FIG. 9). Built into the second lens barrel 52 is a bending optical system including a second front lens 52a (not shown; same configuration as the bending optical system P). When the slide cover 20 has been slid downward to open the first and second lens barrels 51 and 52, the first and second front lenses 51a and 52a are exposed through an opening (not shown) in the front panel 11.

Configuration of Frame Assembly 50

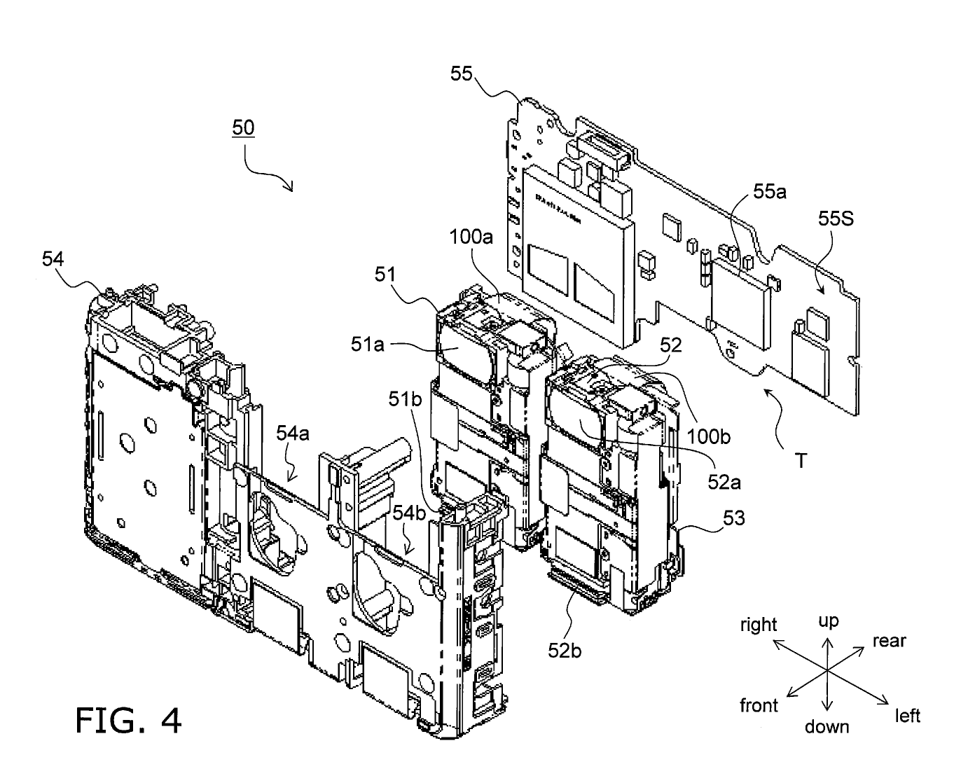

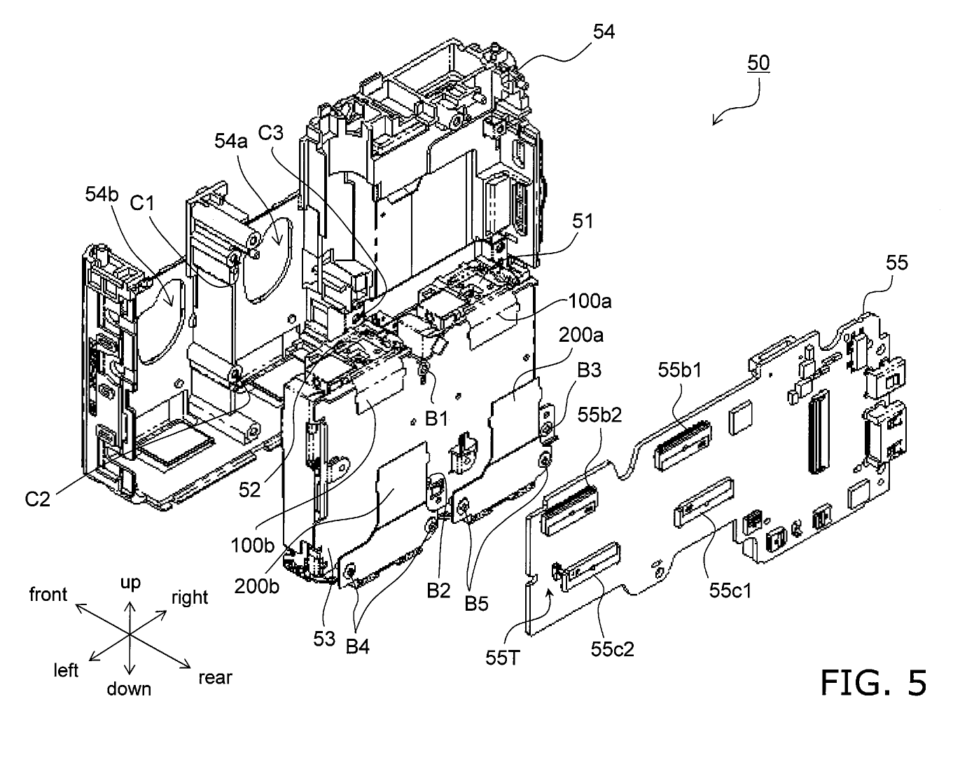

Next, the configuration of the frame assembly 50 will be described through reference to the drawings. FIG. 4 is a front exploded oblique view of the frame assembly 50, and FIG. 5 is a rear exploded oblique view of the frame assembly 50.

In addition to the first and second lens barrels 51 and 52 discussed above, the frame assembly 50 also has a support plate 53, a plastic frame 54, a printed substrate 55, a first flexible substrate 100a, a first rigid flexible substrate 200a, a second flexible substrate 100b, and a second rigid flexible substrate 200b.

The first and second lens barrels 51 and 52 are each disposed in the up and down direction and are next to each other on the left and right. The first and second lens barrels 51 and 52 are fixed to the front face of the support plate 53.

The first lens barrel 51 has the first front lens 51a and a first imaging element 51b. The first front lens 51a is a lens that is disposed the closest to the subject out of the bending optical system P (see FIG. 9). The first front lens 51a takes light from the subject into the interior of the first lens barrel 51. The first imaging element 51b is disposed beneath the bending optical system P. A CMOS sensor can be used favorably as the first imaging element 51b, but this is not the only option, and a CCD or the like can be used instead.

The second lens barrel 52 has the second front lens 52a and a second imaging element 52b. The second front lens 52a is a lens that is disposed closest to the subject out of the bending optical system P. The second front lens 52a takes light from the subject into the interior of the second lens barrel 52. The second imaging element 52b is disposed beneath the bending optical system P. A CMOS sensor can be used favorably as the second imaging element 52b, but this is not the only option, and a CCD or the like can be used instead.

The support plate 53 is a sheet metal member formed in a flat shape. The support plate 53 is disposed between the first and second lens barrels 51 and 52 and the printed substrate 55, and supports the first and second lens barrels 51 and 52. The support plate 53 is fixed to the plastic frame 54 by first to third screws B1 to B3. The first and second rigid flexible substrates 200a and 200b are fixed to the support plate 53 by fourth and fifth screws B4 and B5.

The plastic frame 54 has a first holder 54a, a second holder 54b, and first to third bosses c1 to c3. The first and second lens barrels 51 and 52 are held in the first and second holders 54a and 54b. The first to third screws B1 to B3 are inserted into the first to third bosses c1 to c3.

The printed substrate 55 has an integrated circuit 55a, a first upper connector 55b1, a first lower connector 55c1, a second upper connector 55b2, and a second lower connector 55c2.

The integrated circuit 55a is disposed on the front face 55S of the printed substrate 55, and is opposite the support plate 53. The integrated circuit 55a transmits control signals to the first and second lens barrels 51 and 52 via the first and second flexible substrates 100a and 100b. The integrated circuit 55a acquires image signals from first and second imaging elements 51d and 52d via the first and second rigid flexible substrates 200a and 200b. The integrated circuit 55a subjects the acquired image signals to processing, thereby displaying an image on the monitor 30, or storing image data, for example.

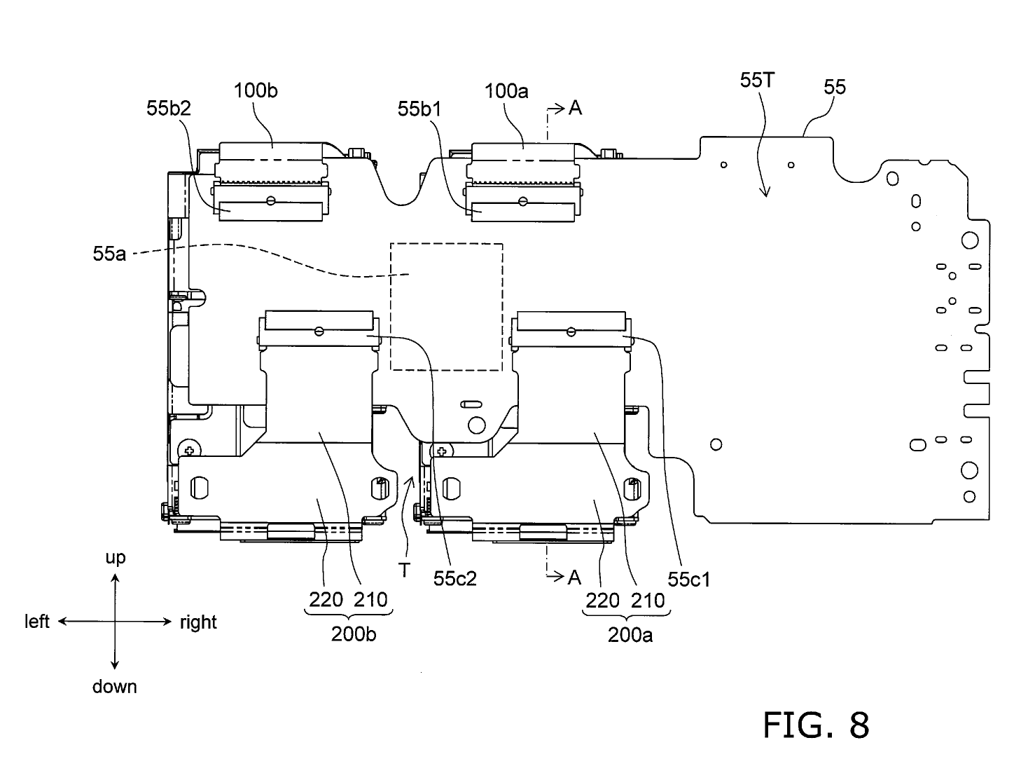

The first and second upper connectors 55b1 and 55b2 and the first and second lower connectors 55c1 and 55c2 are disposed on the rear face 55T of the printed substrate 55. The first and second upper connectors 55b1 and 55b2 are disposed above the first and second lower connectors 55c1 and 55c2. These four connectors are disposed in a balanced layout around the integrated circuit 55a (see FIG. 8). Specifically, in plan view, the spacing between each of the four connectors and the integrated circuit 55a is about the same.

As shown in FIG. 4, the printed substrate 55 has a notched part T formed beneath the integrated circuit 55a. Accordingly, the printed substrate 55 has an overall planar shape that is substantially L-shaped.

The first flexible substrate 100a transmits to the bending optical system P signals for controlling the bending optical system P of the first lens barrel 51 (see FIG. 9). The first flexible substrate 100a is linked to the upper end of the first lens barrel 51, and is bent at approximately 90° so as to conform to the rear face of the printed substrate 55. One end of the first flexible substrate 100a is fixed to the first upper connector 55b1 on the printed substrate 55.

The first rigid flexible substrate 200a transmits the image signals outputted from the first imaging element 51b to the integrated circuit 55a. The first rigid flexible substrate 200a is linked to the lower end of the first lens barrel 51, and is bent at approximately 90° so as to conform to the rear face of the printed substrate 55. One end of the first rigid flexible substrate 200a is fixed to the first lower connector 55c1 on the printed substrate 55.

The second flexible substrate 100b transmits to the bending optical system signals for controlling the bending optical system of the second lens barrel 52. The second flexible substrate 100b is linked to the upper end of the second lens barrel 52, and is bent at approximately 90° so as to conform to the rear face of the printed substrate 55. One end of the second flexible substrate 100b is fixed to the second upper connector 55b2 on the printed substrate 55.

The second rigid flexible substrate 200b transmits the image signals outputted from the second imaging element 52b to the integrated circuit 55a. The second rigid flexible substrate 200b is linked to the lower end of the second lens barrel 52, and is bent at approximately 90° so as to conform to the rear face of the printed substrate 55. One end of the second rigid flexible substrate 200b is fixed to the second lower connector 55c2 on the printed substrate 55.

The first flexible substrate 100a is a member having the same shape as the second flexible substrate 100b, and the first rigid flexible substrate 200a is a member having the same shape as the second rigid flexible substrate 200b.

Configuration of First and Second Rigid Flexible Substrates 200a and 200b

The configuration of the first and second rigid flexible substrates 200a and 200b will be described through reference to the drawings.

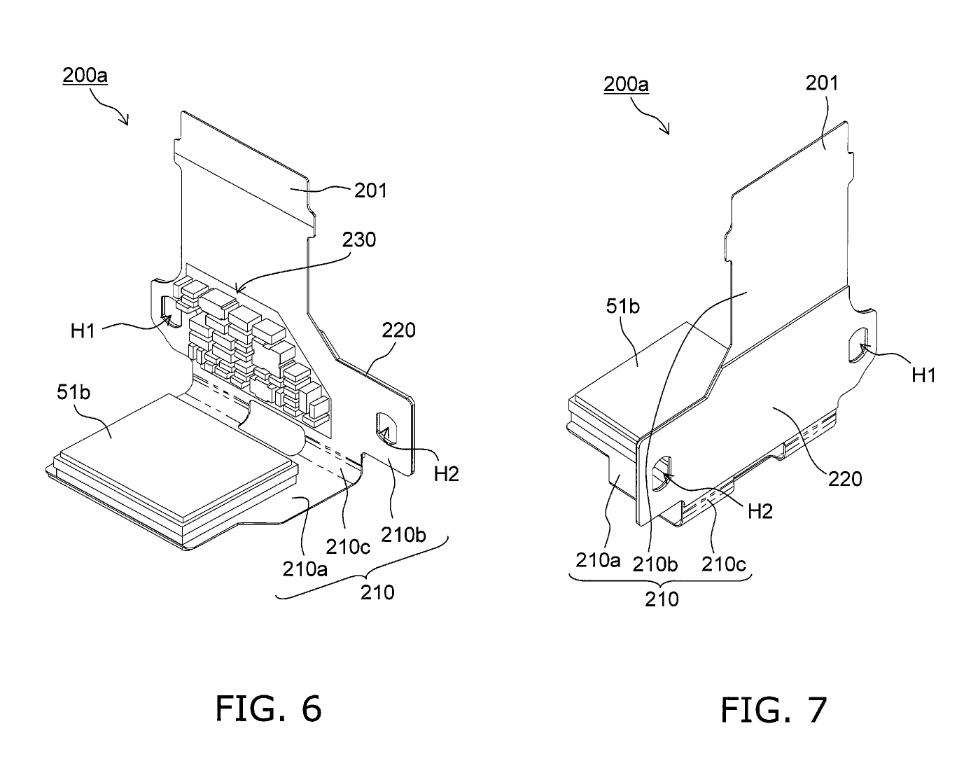

FIG. 6 is a front oblique view of the first rigid flexible substrate 200a. FIG. 7 is a rear oblique view of the first rigid flexible substrate 200a. Since the first and second rigid flexible substrates 200a and 200b have the same configuration, the following description will focus on the configuration of the first rigid flexible substrate 200a.

As shown in FIGS. 6 and 7, the first rigid flexible substrate 200a has a flexible component 210, a rigid component 220, an electronic circuit component 230, and a pair of screw holes H1 and H2.

The flexible component 210 is made of a polyimide resin, for example, and is formed in the shape of a flexible film. The flexible component 210 has a first portion 210a, a second portion 210b, and a bent portion 210c. The first portion 210a is disposed parallel to the first imaging element 51b, and is connected to the lower face of the first imaging element 51b. The second portion 210b is disposed substantially perpendicular to the first portion 210a. The second portion 210b includes an upper end 201 that is inserted into the first lower connector 55c1. The bent portion 210c is bent at approximately 90°, and links the first portion 210a and the second portion 210b.

The rigid component 220 is made of glass epoxy resin, for example, and is formed in a flat shape. The rigid component 220 is stuck to the rear face of the second portion 210b out of the flexible component 210. Therefore, the rigid component 220 is disposed substantially perpendicular to the first portion 210a of the flexible component 210.

FIG. 8 is a rear view of the state when the first and second rigid flexible substrates 200a and 200b have been connected to the printed substrate 55. The support plate 53 is not shown in FIG. 8, however. As shown in FIG. 8, the rigid component 220 is disposed within the notched part T formed in the printed substrate 55 in a plan view of the substrate rear face 55T. More specifically, the pair of rigid components 220 had by the first and second rigid flexible substrates 200a and 200b are next to each other on the left and right within the notched part T. Thus, in this embodiment, the pair of rigid components 220 is laid out so as to fit into the notched part T in the L-shaped printed substrate 55, and as a result, the printed substrate 55 and the pair of rigid components 220 are held within a rectangular range that is wider than it is long overall.

The electronic circuit component 230 is fixed to the front face of the second portion 210b out of the flexible component 210. The electronic circuit component 230 is disposed on the opposite side from the rigid component 220 with the second portion 210b in between, and is supported by the rigid component 220. The electronic circuit component 230 subjects image signals outputted from the first imaging element 51b to A/C conversion processing and so forth.

The screw holes H1 and H2 go through the rigid components 220 and the second portion 210b of the flexible component 210. The fourth and fifth screws B4 and B5 (see FIG. 5) for fixing the first rigid flexible substrate 200a to the support plate 53 are inserted into the screw holes H1 and H2.

FIG. 9 is an A-A cross section of FIG. 8. As shown in FIG. 9, the rigid component 220 and the electronic circuit component 230 are disposed in the rear of the lower end of the first lens barrel 51. Also, the rigid component 220 and the electronic circuit component 230 are disposed between the first imaging element 51b and the lower end of the printed substrate 55 in the up and down direction. Part of the electronic circuit component 230 is disposed in front of the rear face 55T of the printed substrate 55. That is, part of the electronic circuit component 230 is disposed more to the first lens barrel 51 side than a reference line L that passes through the rear face 55T. In this embodiment, since only part of the electronic circuit component 230 is disposed in front of the reference line L, the electronic circuit component 230 and the reference line L overlap, but if the entire electronic circuit component 230 is disposed in front of the reference line L, then the electronic circuit component 230 will not overlap the reference line L.

Action and Effect

(1) The digital camera 1 pertaining to this embodiment comprises the printed substrate 55, the first and second lens barrels 51 and 52, and the first and second rigid flexible substrates 200a and 200b. The first and second rigid flexible substrates 200a and 200b each have a flexible component 210, a rigid component 220, and an electronic circuit component 230. Part of the electronic circuit component 230 is disposed in front of the rear face 55T (an example of a rear face) of the printed substrate 55.

Therefore, the space formed between the electronic circuit component 230 and the first lens barrel 51 in the longitudinal direction can be reduced over that when the electronic circuit component 230 is disposed in the rear of the rear face 55T. Accordingly, the digital camera 1 can be made thinner in the longitudinal direction.

(2) The first and second imaging elements 51b and 52b are disposed substantially perpendicular to the rear face 55T. The rigid component 220 is disposed substantially parallel to the rear face 55T.

Therefore, the height of the digital camera 1 in the up and down direction can be reduced over that when the rigid component 220 is disposed parallel to and below the first imaging element 51b or the second imaging element 52b.

(3) The printed substrate 55 has the notched part T. The rigid component 220 of each of the first and second rigid flexible substrates 200a and 200b is disposed within the notched part T in a plan view of the rear face 55T.

Therefore, the printed substrate 55 and the pair of rigid components 220 can be combined so that the layout of the two is more compact.

(4) The first rigid flexible substrate 200a has the same shape as the second rigid flexible substrate 200b. Therefore, the manufacturing cost can be lowered over that when the first and second rigid flexible substrates 200a and 200b are formed in external shapes that are in left and right symmetry to each other.

### Other Embodiments

The present invention was described by the above embodiment, but the text and drawings that form part of this disclosure should not be construed as limiting this invention. Various alternate embodiments, working examples, and applied technology should be clear to a person skilled in the art from this disclosure.

(A) In the above embodiment, a case was described in which the digital camera 1 had two lens barrels, but this is not the only option. The digital camera 1 may have three or more lens barrels.

(B) In the above embodiment, the rigid components 220 were stuck to the rear faces of the flexible components 210, but this is not the only option. As shown in FIG. 10, the rigid component 220 may be stuck to the front face of the flexible component 210. In this case, at least part of the electronic circuit component 230 and/or the flexible component 210 may be disposed in front of the rear face 55T.

(C) In the above embodiment, the frame assembly 50 comprised the support plate 53, but this is not the only option. The frame assembly 50 need not comprise the support plate 53. In this case, the first and second lens barrels 51 and 52 may be supported by the plastic frame 54, etc.

(D) In the above embodiment, the first and second rigid flexible substrates 200a and 200b were fixed to the support plate 53 by the fourth and fifth screws B4 and B5, but this is not the only option. The first and second rigid flexible substrates 200a and 200b need not be fixed to the support plate 53.

(E) In the above embodiment, the digital camera 1 was described as an example of an “imaging device,” but this is not the only option. Examples of an “imaging device” include a video camera, a portable telephone, and an IC recorder.

Thus, it should go without saying that the present invention encompasses various embodiments not discussed herein. Therefore, the technological scope of the present invention is defined only by the matters specifying the invention, pertaining to the appropriate claims, as described above.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of an imaging device. Accordingly, these terms, as utilized to describe the present invention should be interpreted relative to an imaging device.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An imaging device, comprising:
a flat printed substrate including:
a front face,
a rear face,
a first connector disposed on the rear face, and
a second connector disposed on the rear face;
a first lens barrel disposed on the front face side of the flat printed substrate, the first lens barrel including a first imaging element;
a second lens barrel disposed on the front face side of the flat printed substrate, the second lens barrel including a second imaging element;
a first rigid flexible substrate linked to the first imaging element and the first connector, the first rigid flexible substrate including:
a first flexible component connected to the first imaging element and the first connector,
a first rigid component disposed in the rear of the first lens barrel, and
a first electronic circuit component supported by the first rigid component;
a second rigid flexible substrate linked to the second imaging element and the second connector, the second rigid flexible substrate including:
a second flexible component connected to the second imaging element and the second connector,
a second rigid component disposed in the rear of the second lens barrel, and
a second electronic circuit component supported by the second rigid component;
wherein at least part of at least one of the first flexible component and the first electronic circuit component is disposed in front of the rear face of the flat printed substrate; and
wherein at least part of at least one of the second flexible component and the second electronic circuit component is disposed in front of the rear face of the flat printed substrate.

2. The imaging device according to claim 1, wherein:
the first imaging element is disposed substantially perpendicular to the rear face;
the second imaging element is disposed substantially perpendicular to the rear face;
the first rigid component is disposed substantially parallel to the rear face; and
the second rigid component is disposed substantially parallel to the rear face.

3. The imaging device according to claim 1, wherein:
the flat printed substrate further includes a notched part;
the first rigid component is disposed inside the notched part in a plan view of the rear face; and
the second rigid component is disposed inside the notched part in a plan view of the rear face.

4. The imaging device according to claim 1, wherein:
the first rigid flexible substrate and the second rigid flexible substrate have the same shape.

5. The imaging device according to claim 1, wherein:
the imaging device includes three or more lens barrels.

6. The imaging device according to claim 1, wherein:
the first rigid component is disposed on the rear face of the first flexible component; and
the second rigid component is disposed on the rear face of the second flexible component.

7. The imaging device according to claim 1, wherein:
the first rigid component is disposed on the front face of the first flexible component; and
the second rigid component is disposed on the front face of the second flexible component.
